(19) United States
(12) Patent Application Publication
(10) Pub. No.: US 2025/0068967 A1
(43) Pub. Date: Feb. 27, 2025

(54) System and Techniques for Event Prediction from Observed Event Sequences

(71) Applicant: Robert Bosch GmbH, Stuttgart (DE)

(72) Inventors: HyeongSik Kim, San Jose, CA (US); Andrew Le Clair, London (CA); Zhengyu Zhou, Fremont, CA (US); Abhishek Saini, Seattle, WA (US); Pongtep Angkititrakul, Dublin, CA (US)

(21) Appl. No.: 18/456,226

(22) Filed: Aug. 25, 2023

(51) Int. Cl. G06N 20/00

(52) U.S. Cl. CPC G06N 20/00

(57) ABSTRACT

An event analysis and prediction system is disclosed that is configured to analyze at least one event data stream from a monitored system for the purpose of predicting future events in the system, e.g., for predictive maintenance of the system. The event analysis and prediction system advantageously predicts, in real-time, such failures in the monitored system that would otherwise lead to interruptions. The event analysis and prediction system advantageously leverages a novel data generation procedure that, in essence, converts the problem of failure prediction to a classification problem, which is solved using machine learning algorithms. The event analysis and prediction system is designed to work well even when there is limited labeled data available for model training.

### FIELD

The device and method disclosed in this document relates to system event analysis and, more particularly, to predicting events from observed event sequences.

### BACKGROUND

Unless otherwise indicated herein, the materials described in this section are not admitted to be the prior art by inclusion in this section.

Many real-world systems emit sequences of observed events, where each event captures a particular behavior of the system (e.g., abnormal/anomalous behaviors). For example, modern manufacturing plants often produce many different types of data as streams, such as event logs from their machines. Timestamped sequences of observed events can be collected from a variety of sources such as software logs, the output of an anomaly detection engine, device diagnostics logs, and more.

Occasionally, these events may result in another critical event in the system, (i.e., system failures, etc.) which can lead to downtime and potential revenue loss. For example, in a typical manufacturing plant, machines may be placed at specific locations and may form ‘lines’ of machines. In each line of machines, the output of the machine is automatically fed as input for the next machine in the line so that the manufacturing process can be automated. However, this does not mean that the operations of the machines are completely free from any occurrence of errors or halts. In many cases, the machines begin to operate erratically or do not behave as intended as their operations are continued over time. In such cases, the machines require a halting order so that human operators or experts may address the underlying issue, or the machines may halt on their own unpredictably. Regardless of whether this halting was planned or unplanned, every second that the machine is not operating is a direct loss of productivity and, thus, a loss quantifiable in dollars.

Predictive maintenance (PdM) is a promising approach to predict and prevent such interruptions in manufacturing plants and other real-world system. Predictive maintenance uses the data collected from a system (e.g., from machines in a manufacturing plant) to make predictions about the future failures in the system. This helps in detecting and mitigating system failures, thus extending system uptime and reducing system maintenance costs. What is needed is a method for predictive maintenance that better leverages the historical data from a system to accurately and reliably predict future system failures.

### SUMMARY

A method is disclosed for training a machine learning model to predict future events in a system. The method comprises receiving, with a processor, event data from the system, the event data indicating events that occurred in the system and times at which the events occurred. The method further comprises determining, with the processor, a plurality of positive training samples based on the event data. The method further comprises determining, with the processor, a plurality of negative training samples based on the event data. The method further comprises training, with the processor, using the plurality of positive training samples and the plurality of negative training samples, a machine learning model to predict, given a sequence of events that have occurred at a particular location during a window of time, whether a particular type of event will occur at the particular location within a first threshold amount of time subsequent to the window of time.

A method is disclosed for predicting possible future events in a system. The method comprises receiving, with a processor, event data from the system, the event data indicating events that occurred in the system and times at which the events occurred. The method further comprises determining, with the processor, a sequence of events including events that occurred at a respective location within the system and during a window of time preceding a current time. The method further comprises predicting, with the processor, based on the sequence of events, using a machine learning model, whether a particular type of event will occur at the respective location within a first threshold amount of time subsequent to the window of time. The method further comprises perceptibly outputting, with a user interface, an alert in response to predicting that the particular type of event will occur at the respective location within the first threshold amount of time subsequent to the window of time.

### BRIEF DESCRIPTION OF THE DRAWINGS

The foregoing aspects and other features of the systems and methods are explained in the following description, taken in connection with the accompanying drawings.

FIG. 1 shows an event analysis and prediction system according to the disclosure.

FIG. 2 shows an exemplary embodiment of a computing device used to analyze an event data stream and predict future events.

FIG. 3 shows an example visualization of an event-location timeline.

FIG. 4 shows a flow diagram for a method for training a machine learning model to predict future events in a system.

FIG. 5 shows a flow diagram for a method for predicting possible future events in a system.

FIG. 6. shows a stepwise scan of an event-location timeline.

FIG. 7 shows an exemplary feature extraction for a positive training sample.

FIG. 8 shows a custom cross-validation split to avoid feature leakage.

FIG. 9 shows the conditions under which a prediction is successful or a false positive.

FIG. 10 shows a scenario where two interruptions occur in the same prediction interval.

FIG. 11 shows an exemplary explanation of which events contribute to a predicted interruption.

FIG. 12 shows a plot showing a resulting precision-recall curve.

FIG. 13 shows a visualization of the generated data across different locations using t-SNE plots.

### DETAILED DESCRIPTION

For the purposes of promoting an understanding of the principles of the disclosure, reference will now be made to the embodiments illustrated in the drawings and described in the following written specification. It is understood that no limitation to the scope of the disclosure is thereby intended. It is further understood that the present disclosure includes any alterations and modifications to the illustrated embodiments and includes further applications of the principles of the disclosure as would normally occur to one skilled in the art which this disclosure pertains.

### Overview

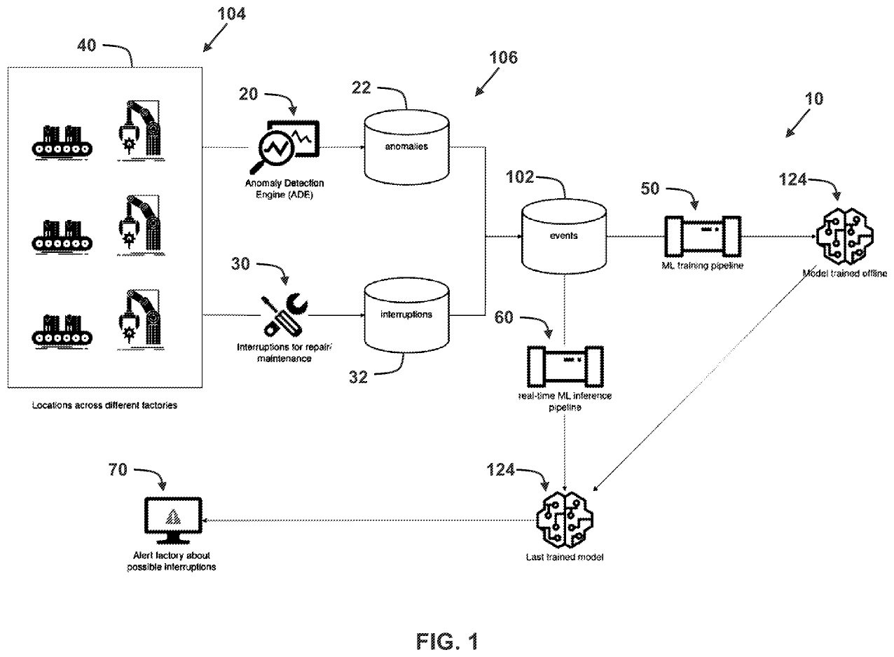

FIG. 1 shows an event analysis and prediction system 10 according to the disclosure. The event analysis and prediction system 10 is configured to analyze at least one event data stream 106 from a monitored system 104 for the purpose of predicting future events in the system 104, e.g., for predictive maintenance of the system 104. As will be discussed in greater detail below, the event analysis and prediction system 10 advantageously predicts, in real-time, such failures in the monitored system 104 that would otherwise lead to interruptions. The event analysis and prediction system 10 advantageously leverages a novel data generation procedure that, in essence, converts the problem of failure prediction to a classification problem, which is solved using machine learning algorithms. The event analysis and prediction system 10 is designed to work well even when there is limited labeled data available for model training.

Throughout the disclosure, the monitored system 104 will be described primarily using the illustrative example of a manufacturing plant having a plurality of machines, with respect to which various events may occur and which are monitored to generate event data. However, it should be appreciated that the event analysis and prediction system 10 may be applied to any system that generates event data, either through self-monitoring or through some other monitoring mechanism.

In the illustrative example, the monitored system 104 is a manufacturing plant that includes a plurality of machines 40. The machines of the manufacturing plant may, for example, include welding stations, storage tanks, mixers, compressors, centrifuges, etc. The machines of the manufacturing plant are each installed at a specific location in the manufacturing plant and with a particular configuration. The machines may be interlinked with each other, forming lines of the machines. In each line of machines, the output of the machines may be automatically fed as input for the next machines in the line so that the manufacturing process can be fully automated. The machines, when operational, are continuously monitored by sensors. These sensors measure various parameters of the machines, such as the position of different components, the angle between components, force applied, pressure, and more. Thus, each location continuously emits different types of data as it operates, which may relate to events such as anomalies, interruptions, and other types of event data over time.

As used here, the term “location” of the machine is not limited to its narrow literal meaning, but instead denotes the “machine” (or station or device) running or operating at a specific physical location using a specific configuration (e.g., function unit, work position, and tool positions). Each location can, therefore, be identified using a unique identifier (location_id) so that it can be identified and selected in databases or other software systems. For each location, a number of parameters are specified by operators or domain experts in the plants. These parameters are therefore associated with each location and the values of these parameters are continuously monitored using sensors and then later stored in databases. The parameters can be any values from the machines such as physical coordinates of parts of the location, measured values of forces, pressures or velocities being applied, etc.

With continued reference to FIG. 1, the event data stream 106 at least includes data indicating events that occurred in the monitored system 104 and timestamps indicating the times at which the events occurred. In the illustrated example, an Anomaly Detection Engine (ADE) 20 monitors, in real time, data (e.g., sensor data) received from the machines 40 in the monitored system 104. The ADE 20 is configured by users in advance to detect various types of anomalous events such as outliers, sudden changes in mean or variance, gradual mean shifts, increases in zero values, etc. Whenever such an anomaly occurs, the details of that anomaly are recorded in an anomalies database 22 in real-time. Some of these anomalies are not critical and could arise purely because of the rules that flag these anomalies. On the other hand, some of these anomalies could hint towards underlying faults within the machines 40 that need to be corrected. Occasionally, these faults can lead to a breakdown of the machines 40, which causes an interruption on the factory line. Whenever such an interruption occurs, a separate interruption processing system 30 records the details of that interruption in a separate interruptions database 32. Thus, the event analysis and prediction system 10 and/or the monitored system 104 incorporates two systems that record events. The event analysis and prediction system 10 combines both sources of event data in the event data stream 106 into single database 102.

As used herein, an “event” denotes any single discrete moment that occurs with respect to a system at a particular time. An event is characterized by a timestamp and a location. Events can be categorized into any number of different event types, depending on the nature of the system (i.e., monitored system 104). In the illustrative example of a manufacturing plant, an event refers to any single discrete moment that occurs a specific location, machine, and/or component at a manufacturing plant, at a particular time. For example, suppose that the manufacturing plant includes a welding machine w located at the manufacturing line m. Suppose that event e₁ happens with respect to the welding machine w at a certain specific time, e.g., 2018 Jun. 12 09:55:22. The event e₁ may, for example, be that a sensor of the welding machine w indicates that some measured parameter has an abnormal value. Subsequently, another event e₂ happens with respect to the welding machine w at a certain specific time, e.g., 2018 Jun. 12 10:51:02. The event e₂ may, for example, be that the operation of this machine w has been interrupted, i.e., its operation has suddenly stopped. From this example, the events e₁ and e₂ can be logically categorized into two event types: “anomalies” (i.e., the event e₁) and “interruptions” (i.e., the event e₂).

As used herein, an “anomaly” is an event denoting a moment when any measurable or observable parameter from any location or any component of a system behaves abnormally, e.g., has an irregular value outside of a predetermined or expected range, or a value trending toward becoming outside of the predetermined or expected range. The predetermined or expected range may be fixed or based on an observed trend for the parameter. In the manufacturing plant example, a temperature of some chamber of some machines being out of a predetermined allowed range, or a velocity of a rotating axis in some other machine being lower than its average speed, might be reported as an anomaly in the event data stream 106. Like other events, an anomaly is characterized by a timestamp and a location. In addition, an anomaly is further characterized by the parameter being measured, the technique used to determine the anomaly, and/or the level of anomaly.

As used herein, an “interruption” is an event denoting a moment when a process of a system is halted, e.g., due to a failure of some component of the system or due to intervention by a human operator or an automated intervention system. In the manufacturing plant example, interruptions could cause a delay of the manufacturing line/process. These delays could result in a halting of manufacturing parts, and has a quantifiable monetary impact, in addition to requiring intervention by experts (e.g., line operators) to address what caused the interruption. Like other events, an interruption is characterized by a timestamp and a location. In addition, an interruption is further characterized by its identifier codes or descriptions, the duration of interruption, the type of interruption, and/or human input text describing the interruption.

It should be appreciated that anomalies and interruptions are mere exemplary event categories and, although this classification scheme is used herein to describe the events of the event data stream 106, it should be appreciated that events can be categorized into any number of different event categories. In a broad manner, the combination of other event categories can also be similarly used with other scenarios, set-ups, configurations, or domains. For example, instead of using anomalies from anomaly detection engines, any other event category, such as warnings or precursor events, can be used as alternatives. Such event categories can be also a component-change event (i.e., some components in machines are often worn out as it operates over time, which need some replacements) or any other alerts from any other monitoring systems installed in locations or plants. Similarly, instead of using interruptions, other critical event categories can be used here, such as scrap-detection events (i.e., the components or products built from the machines were not properly manufactured, which need to be discarded) or any other malfunctions of the stations which need to be prevented in advance.

It should be appreciated that the event categories do not have to be the ones from the manufacturing domain, but any other events from any other domains can be similarly used, e.g., 1) delivery delays might be used to predict interruptions or any other critical events in the transportation domain and 2) anomalies from patient monitoring systems might be used to predict critical events such as heart attacks in healthcare domain to prevent from any sudden illness of patients, etc.

In at least some embodiments, in addition to the data indicating events that occurred in the monitored system 104 and the timestamps indicating the times at which the events occurred, the event data stream 106 may further include certain metadata, such as where the event occurred, what caused the event, what sensors detected the event, a human-input text description of the event, an indication of whether the event was a planned or unplanned interruption, a duration of the event, and other parameters or contextual information etc. In any case, the event analysis and prediction system 10 is configured to analyze and store the data of the event data stream 106 in a database 102.

With reference again to FIG. 1, the task of the event analysis and prediction system 10 is to predict future interruptions given a dataset of historical events stored in the database 102. To this end, the event analysis and prediction system 10 incorporates event prediction software having a machine learning model 124 that is trained to perform an event prediction task, e.g., interruption prediction. In a machine learning training pipeline 50, the machine learning model 124 is trained and updated periodically offline using the anomaly, interruption, and other event data collected in the database 102. Additionally, in a real-time machine learning inference pipeline 60, the latest version of the machine learning model 124 is deployed and used for real-time prediction of interruptions. When an interruption is predicted, the event analysis and prediction system 10 provides an alert 70 to operators of the monitored system 104.

The event analysis and prediction system 10 described herein has a variety of advantages. Particularly, as discussed in greater detail below, the problem of interruption prediction is advantageously treated as binary classification in which the output of the system 10 denotes a probability that an interruption will occur soon. In this way the output of the system 10 is easily understood and interpreted by the operators. Additionally, the system 10 is advantageously able to predict the probability of an interruption with high accuracy. As a result, manufacturing lines are less likely to be stopped for inspections due to false positives. Moreover, the interruption predictions are easily explainable. This will help the operators understand the reason behind predictions and will also help them with inspection. Explainable predictions are also important for early detection of faults in the machine learning model 124. Finally, the system 10 is advantageously able to predict the probability of an interruption in real time. This is important because the operators need to know whether an interruption is likely to occur as soon as possible so that they can take the necessary actions to prevent it.

### Exemplary Hardware Embodiment

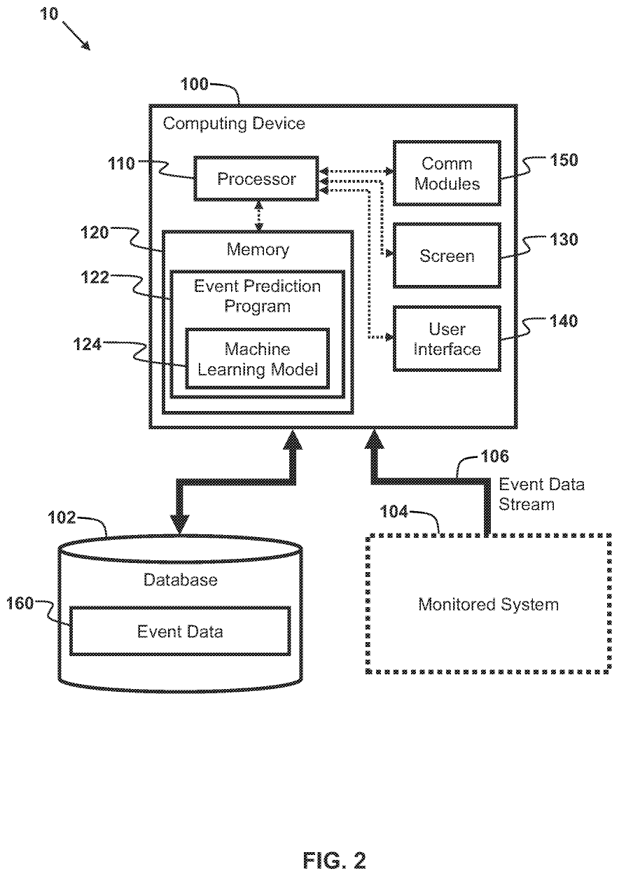

With reference to FIG. 2, an exemplary embodiment of a computing device 100 (e.g., a server) is described that can be used to analyze the event data stream 106 from the monitored system 104 and to predict future events. The computing device 100 comprises a processor 110, a memory 120, a display screen 130, a user interface 140, and at least one network communications module 150. It will be appreciated that the illustrated embodiment of the computing device 100 is only one exemplary embodiment is merely representative of any of various manners or configurations of a server, a desktop computer, a laptop computer, mobile phone, tablet computer, or any other computing devices that are operative in the manner set forth herein. The computing device 100 is in communication with the database 102, which may be hosted by another device or which is stored in the memory 120 of the computing device 100 itself.

The processor 110 is configured to execute instructions to operate the computing device 100 to enable the features, functionality, characteristics and/or the like as described herein. To this end, the processor 110 is operably connected to the memory 120, the display screen 130, and the network communications module 150. The processor 110 generally comprises one or more processors which may operate in parallel or otherwise in concert with one another. It will be recognized by those of ordinary skill in the art that a “processor” includes any hardware system, hardware mechanism or hardware component that processes data, signals or other information. Accordingly, the processor 110 may include a system with a central processing unit, graphics processing units, multiple processing units, dedicated circuitry for achieving functionality, programmable logic, or other processing systems.

The memory 120 is configured to store data and program instructions that, when executed by the processor 110, enable the computing device 100 to perform various operations described herein. The memory 120 may be of any type of device capable of storing information accessible by the processor 110, such as a memory card, ROM, RAM, hard drives, discs, flash memory, or any of various other computer-readable medium serving as data storage devices, as will be recognized by those of ordinary skill in the art.

The display screen 130 may comprise any of various known types of displays, such as LCD or OLED screens, configured to display graphical user interfaces. The user interface 140 may include a variety of interfaces for operating the computing device 100, such as buttons, switches, a keyboard or other keypad, speakers, and a microphone. Alternatively, or in addition, the display screen 130 may comprise a touch screen configured to receive touch inputs from a user.

The network communications module 150 may comprise one or more transceivers, modems, processors, memories, oscillators, antennas, or other hardware conventionally included in a communications module to enable communications with various other devices. Particularly, the network communications module 150 generally includes an ethernet adaptor or a Wi-Fi® module configured to enable communication with a wired or wireless network and/or router (not shown) configured to enable communication with various other devices. Additionally, the network communications module 150 may include a Bluetooth® module (not shown), as well as one or more cellular modems configured to communicate with wireless telephony networks.

In at least some embodiments, the memory 120 stores program instructions of an event analysis program 122 that can be used to analyze the event data stream 106 from the monitored system 104 and to predict future events, and which at least includes the machine learning model 124 configured for real-time prediction of future events (e.g., interruptions) in the monitored system 104. The database 102 at least stores a plurality of event data 160, which includes the raw data indicating events that occurred in the monitored system 104, the timestamps indicating the times at which the events occurred, and the various metadata discussed above. These event data 160 are used to train the machine learning model 124 in an offline setting to perform the task of interruption prediction.

### Reformulating Event Prediction as a Classification Problem

Since events can occur at different locations and at different times, the following definitions are leveraged to distinguish the events that occur in the monitored system 104. First, an event set is defined (definition 2.1) as a way to refer to all anomalies and interruptions within the monitored system 104. Particularly, let E be a set of all events, defined as E:=A∪I. In this and other definitions, A is a set of all anomalies and I is a set of all interruptions. Thus, E denotes the set of all events that exist in the database 102.

Next, a location function is defined (definition 2.2) that relates the event set E to a set of locations L. Particularly, let loc:E→L be a location function whose input is a particular event e and whose output is a particular location l at which the event e occurred. In this and other definitions, e is any particular event such that e∈E, L is the set of all locations, and l is any particular location such that l∈L.

Similarly, a timestamp function is defined (definition 2.3) that relates the event set E to times at which the events occurred. Particularly, let ts:E→t be a timestamp function whose input is a particular event e and whose output is a timestamp t at which the event e occurred. In this and other definitions, t is any timestamp such that t∈

[symbol]

Together, with both the location function loc and the timestamp function ts, the particular time t and particular location l at which any particular event e occurred can be uniquely identified.

With these functions, an event-location set is defined (definition 2.4) that is composed of all events that have occurred at a given location. As used herein, an “event-location set” is a timestamped sequence of events that have occurred at a particular location. Particularly, let H^{l} be a set of all events that have occurred at a particular location l, which is defined as:

$${H}^{l} := \{ e ∈ E \vert loc ( e ) = l \} .$$

However, event-location set contains all events that ever occurred at that location. To discretize this set into a timeline, time intervals are defined (definition 2.5). Particularly, let a time interval [t₁, t₂] be the set of all times or timestamps that are between and including the start time t₁ and the end time t₂, which is defined as:

$$[ {t}_{1} , {t}_{2} ] := \{ t ∈ ℝ \vert {t}_{1} \leq t \leq {t}_{2} \} .$$

Similarly, half-open and open time intervals are defined as:

$$\begin{matrix}( {t}_{1} , {t}_{2} ] := \{ t ∈ ℝ \vert {t}_{1} < t \leq {t}_{2} \} , \\ [ {t}_{1} , {t}_{2} ) := \{ t ∈ ℝ \vert {t}_{1} \leq t < {t}_{2} \} , \\ ( {t}_{1} , {t}_{2} ) := \{ t ∈ ℝ \vert {t}_{1} < t < {t}_{2} \} .\end{matrix}$$

Next, an event-location timeline is defined (definition 2.6) to refer to all the events that have occurred at a given location before a fixed time. Particularly, let a timeline H_{(-∞,t}_{₂}_{]}^{l} be a set of all events that have occurred at a location l within a time interval (−∞, t₂], i.e., on or before time t₂. The event-location timeline H_{(-∞,t}_{₂}_{]}^{l} is defined as:

$${H}_{( - ∞ , {t}_{2} ]}^{l} := \{ e ∈ E \vert loc ( e ) = l ⋀ ts ( e ) \leq {t}_{2} \} .$$

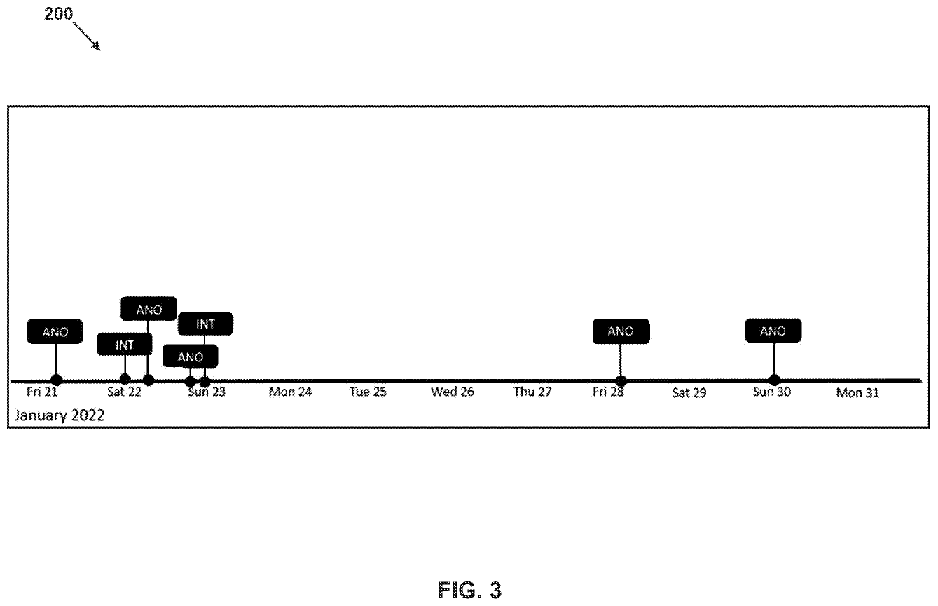

It should be appreciated that this event-location timeline is specific to a single location, and provides a way to represent a location's past, from a given point of time. FIG. 3 shows an example visualization 200 of an event-location timeline including event data between the exemplary dates of Jan. 21, 2022 to Jan. 31, 2022. In the example time 200, each box denotes either an anomaly event (indicated with “ANO”) or an interruption event (indicated with “INT”). The timeline 200 captures the temporal relationship between the events from various datasets in a single view, e.g., certain groups of anomalies often arise before interruptions are occurred.

However, the function that predicts whether an interruption will occur given a sequence of events, is not unique to a single location. Rather, the function would predict interruptions across multiple locations. Thus, a set of all event-location timelines is defined (definition 2.7) to account for all timelines at all locations. Particularly, let [symbol] be a set of all timelines at all locations L, which is defined as:

$$ℍ := {H}_{( - ∞ , t ]}^{l} \vert l ∈ L ⋀ t ∈ ℝ \} ,$$

where H_{(-∞,t]}^{l} is the event-location timeline at each particular location l at the time t.

Next, a predictor function is defined (definition 2.8) for predicting whether an interruption will occur at a particular location soon (i.e., within a first threshold amount of time A). Particularly, let predict: H→[0, 1] be a predictor function whose input is an event-location timeline H at a particular location l at a particular time t and whose output is a probability that an interruption will occur at that location soon. This predictor function, as defined, makes the implicit assumption that the probability of an interruption soon occurring at a location l at a time t depends only on the event-location timeline seen at the location l at the time t.

The goal of the training process for the machine learning model 124 is to learn the predictor function. The output of predict is constrained to be in between 1 (extremely likely that an interruption will occur) and 0 (extremely likely that no interruption will occur). One of the reasons why learning predict is challenging is because it currently looks at the entire timeline that from the time t extended back until data first started being collected. However, based on inputs from domain experts, a simplifying assumption can be made that that only the most recent events are predictive of the probability of an interruption occurring soon. Hence, all events that occurred before a monitoring window duration M can be ignored from when making a prediction of whether an interruption will occur soon. Thus, a window of events between time t (the time of interest) and t-M can be defined to simplify the task of interruption prediction.

A window of events is defined (definition 2.9) for constraining an event-location set to a particular limited time interval. Particularly, let H₍ₜ_{₁}_{,t}_{₂}_{]}^{l} be a window of events that occur at the location l and within the time interval (t₁, t₂], which is defined as:

$${H}_{( {t}_{1} , {t}_{2} ]}^{l} := \{ e ∈ E \vert loc ( e ) = l ⋀ ts ( e ) ∈ ( {t}_{1} , {t}_{2} ] \} .$$

With this definition of a window of events, and with a specific monitoring window duration M (e.g., 7 days), a monitoring window of events H_{(t-M,t]}^{l} is defined for the task of interruption prediction. Finally, a simplified predictor function is defined (definition 2.10) that utilizes this monitoring window of events H_{(t-M,t]}^{l}, rather than the entire event location timeline H_{(-∞,t]}^{l}. Particularly, let simp_predict: [symbol] ′→[0, 1] be a simplified predictor function that takes in a window of events having a duration M at some location l and time t and returns the probability that an interruption will occur at that location l soon. [symbol] ′ is the set of all possible window of events of duration M and is defined as:

$${ℍ}^{′} = \{ {H}_{( t - M , t ]}^{l} \vert l ∈ L ⋀ t ∈ ℝ \} .$$

The output of the simp_predict function can be interpreted as the conditional probability that an interruption will occur, given a monitoring window of events H_{(t-M,t]}^{l}. As discussed in greater detail below, the machine learning model 124 is trained to approximate the simplified predictor function simp_predict using positive and negative training samples generated from the event data 160 collected from the monitored system 104. The machine learning model 124 may take a wide variety of forms suitable for a binary classification problem, such as logistic regression, SVMs, LDA, random forests, and XGBoost.

### Methods for Training and Using a Model to Predict Events

A variety of operations and processes are described below for operating the computing device 100 to train a machine learning model using historical data of the event data stream 106 from the monitored system 104 and to utilize the trained machine learning model 124 to predict probabilities of future events that may occur in the monitored system 104 based on real-time data of event data stream 106. In these descriptions, statements that a method, processor, and/or system is performing some task or function refers to a controller or processor (e.g., the processor 110 of the computing device 100) executing programmed instructions stored in non-transitory computer readable storage media (e.g., the memory 120 of the computing device 100) operatively connected to the controller or processor to manipulate data or to operate one or more components in the computing device 100 or of the database 102 to perform the task or function. Additionally, the steps of the methods may be performed in any feasible chronological order, regardless of the order shown in the figures or the order in which the steps are described.

For a better understanding of the problems that might be solved using the event prediction, the methods are described with respect to the illustrative example in which the monitored system 104 is a manufacturing plant having a plurality of machines, with respect to which various events may occur and which are monitored to generate event data. In the illustrative example, the methods are used to predict interruptions in the manufacturing plant on the basis of anomalies that have occurred in the manufacturing plant. However, it should be appreciated that the systems and methods described herein can be applied to any domain and the references herein to the manufacturing domain and terminologies thereof should be understood to be merely exemplary.

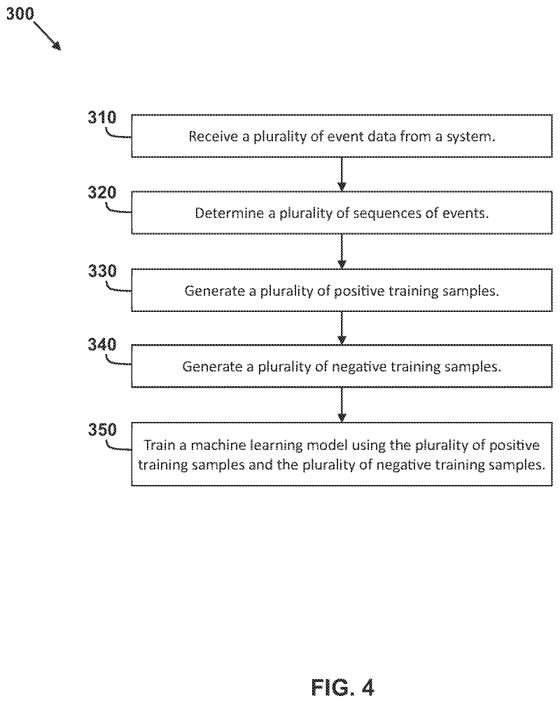

FIG. 4 shows a flow diagram for a method 300 for training a machine learning model to predict future events in a system. The method 300 advantageously converts a stream of event data received from a monitored system 104 into a large number of positive and negative training samples for a binary classification problem. This helps efficiently transform an event sequence prediction task to a simpler classification problem which is relatively easier to solve using machine learning algorithms. Moreover, the process of generating positive and negative training is a procedural process that does not require manual human-annotation of training data. Thus, the machine learning model 124 can be trained on real-world data from a monitored system 104, without the need for manually labeling historical data from the system 104.

The method 300 begins with receiving a plurality of event data from a system (block 310). Particularly, the processor 110 receives the event data stream(s) 106 from the monitored system 104. As discussed above, the event data stream(s) 106 at least include data indicating events that occurred in the monitored system 104 and timestamps indicating the times at which the events occurred. Additionally, the event data stream(s) 106 may further include certain metadata, as discussed above. In at least some embodiments, the processor 110 stores the events from the event data stream(s) 106 in the database 102 (i.e., the event data 160).

The method 300 continues with determining a plurality of sequences of events (block 320). Particularly, the processor 110 determines a plurality of sequences of events, or more particularly, a plurality of windows of events [symbol] ′ at all locations L based on the event data 160. As will be discussed in greater detail below, each window of events in the plurality of windows of events [symbol] ′ is a candidate for generating a positive training sample or a negative training sample. However, it should be appreciated that, in some embodiments, the determination of the plurality of windows of events [symbol] ′ at all locations L is performed concurrently or in conjunction with the processes described below for forming positive and negative training samples, and the description should not be understood to require a particular order of operations or exclude feasible alternative orders of operation.

Each window of events H₍ₜ_{₁}_{,t}_{₂}_{]}^{l} in plurality of windows of events includes events that occurred at a same respective location l within the system 104 and during a respective window/interval of time (t₁, t₂]. In at least some embodiments, each respective window/interval of time (t₁, t₂] has a same length equal to the monitoring window duration M.

To determine the plurality of windows of events [symbol] ′, the processor 110 first determines a plurality of event-location sets H^{l}, or more particularly, a plurality of event-location timelines H_{(-∞,t]}^{l}. Each event-location timeline H_{(-∞,t]}^{l} includes all events the event data 160 that occurred at a same respective location l within the system 104 up until a current time t. Next, the processor 110 determines, for each event-location timeline H₍ₜ_{ₐ}_{,t}_{_{b}}_{]}^{l}, a subset of windows of events that occurred at the same respective location l, but during different respective windows/intervals of time (tₐ, t_{b}]. The processor 110 forms the plurality of windows of events [symbol] ′ at all locations L from the subsets of sequences of events that occurred at the individual locations l.

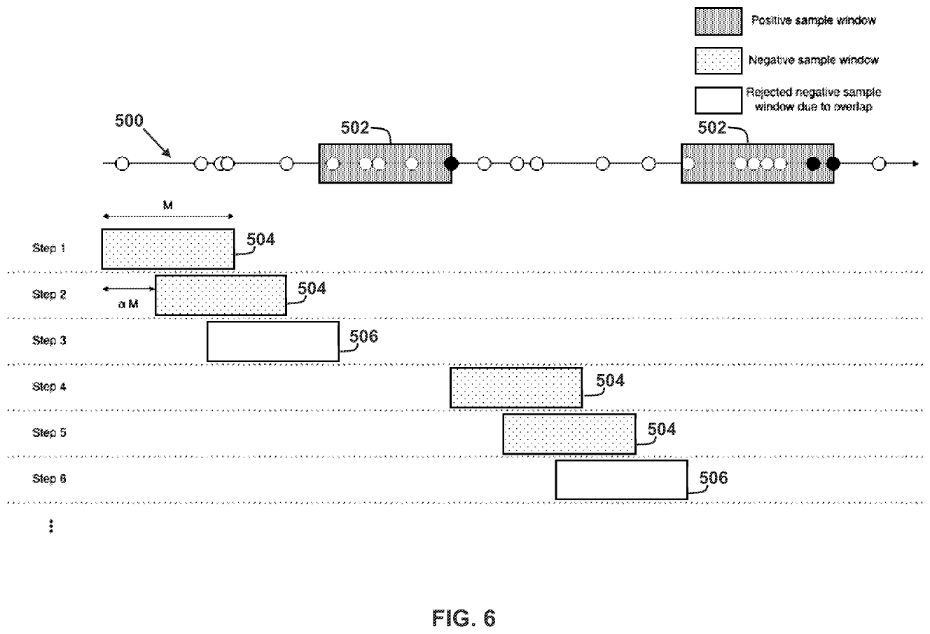

In some embodiments, for each event-location timeline H_{(-∞,t]}^{l}, the processor 110 determines the subset of windows of events that occurred at the respective location l using a sliding window or step-wise scan approach. FIG. 6. shows a stepwise scan of an event-location set 500. The processor 110 scans the event-location set 500 (H^{l}) from a minimum timestamp tₘᵢₙ^{l} to a maximum timestamp tₘₐₓ^{l}. The minimum and maximum timestamps for generating windows of events in H^{l} are tₘᵢₙ^{l}=min{ts(e)|e∈H^{l}} and tₘₐₓ^{l}=max{ts(e)|e∈H^{l}}. In the illustration, anomalies are show as white circles on the event-location set 500 and interruptions are shown as black circles on the event-location set 500. The processor 110 starts, at step 1, by defining a window of events across a time interval (tₘᵢₙ^{l}, tₘᵢₙ^{l}+M]. At step 2, the processor 110 defines a second window of events by sliding the time interval rightwards by a duration that is a fraction α of the monitoring window duration M. Therefore, the next window/interval of time becomes (tₘᵢₙ^{l}+αM, tₘᵢₙ^{l}+M+αM] and the second window of events is defined on across that window/interval of time. In one embodiment, the fraction α is between 0 and 1 and is chosen by cross-validation. The processor 110 repeats this process for steps 3, 4, 5, 6, and so on, until tₘₐₓ^{l} is reached to define a set of different windows/intervals of time that correspond to a set of windows of events that occurred at the location l. The processor 110 repeats this process for each location l in the system 104 to define the plurality of windows of events [symbol] ′.

Each training sample, positive or negative, will comprise (1) data defining a respective window of events H₍ₜ_{ₐ}_{,t}_{_{b}}_{]}^{l} that occurred at a respective location l within the system 104 and during a respective window/interval of time (tₐ,t_{b}] and (2) a classification label c indicating whether a particular type of event (e.g., an interruption) occurred within a first threshold amount of time A (e.g., 7 days) subsequent to the respective window of time (tₐ, t_{b}]. However, in order to apply machine learning, in at least some embodiments, the processor 110 converts the plurality of windows of events [symbol] ′ into feature data that can be processed by the machine learning model 124. Particularly, for each respective window of events in the plurality of windows of events [symbol] ′ (or at least those that are used as training samples), the processor 110 extracts feature data from the respective window of events and forms a feature vector from the feature data. This feature vector is the data that defines or characterizes the respective window of events and that is provided as input to the machine learning model 124 during training.

The feature data extracted from the windows of events [symbol] ′, and/or from individual events thereof, may include any of a variety of features that might benefit the classification task (e.g., n-grams, pattern-based features, timestamps, etc.). In one embodiment, the processor 110 uses a unigram feature extraction (bag of 1-grams) approach to generate features. Particularly, for each respective event type in a plurality of event types of the event data 160, the processor 110 determines a respective count of how many events of the respective event type occurred during the respective sequence of events. These counts of each event type in a respective window of events are combined to form the feature vector that defines or characterizes the respective window of events. In this approach, a feature vocabulary is defined from the set of all unique values of the event type field in the events data 160 (e.g., each type of anomaly). In some embodiments, since an anomalous event doesn't have a type field, a parameter field is used instead to denote the type. The parameter field can be used to denote the type of anomaly because it represents which sensor measurements at that location which saw an anomaly. The assumption is that anomalies at certain parameters will be useful in detecting interruptions. Thus, each unique anomaly type (i.e., unique value in the parameter field) is represented as a feature and its value is the count of that anomaly type in the window of events.

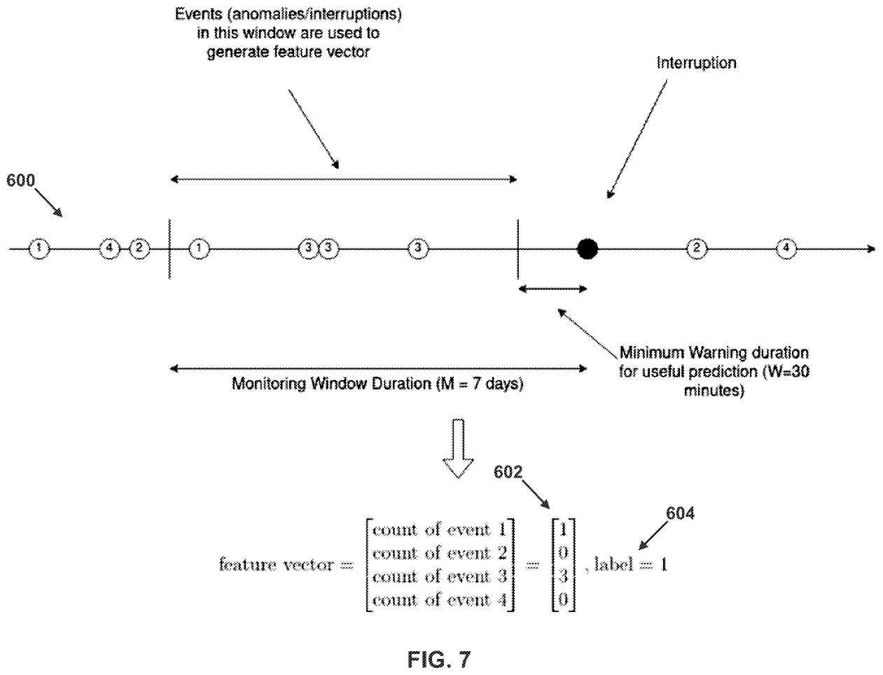

FIG. 7 shows an exemplary feature extraction for a positive training sample. Particularly, an event-location timeline 600 includes anomalies of types 1, 2, 3, and 4. With an exemplary window of events, there is one anomaly of type 1, zero anomalies of type 2, three anomalies of type 3, and zero anomalies of type 4. Thus, the processor 110 forms a feature vector 602 having a length of four and having the values [1, 0, 3, 0]. It should be appreciated, however, that the feature vector 602 may incorporate any number of additional features extracted from the window of events.

Returning to FIG. 4, the method 300 continues with generating a plurality of positive training samples (block 330). Particularly, in order to generate positive training samples (i.e., feature-label pairs), the processor 110 determines which windows of events in the plurality of windows of events [symbol] ′ should be labeled with a classification label c=1, indicating that a particular type of event (e.g., an interruption) occurred within the first threshold amount of time A (e.g., 7 days) subsequent to the window of events. In at least some embodiments, the processor 110 generates positive training samples first because interruptions are rare. With reference to the example of FIG. 7, an interruption occurs subsequent to the window of events and, thus, the processor 110 determines that the classification label 604 should be equal to 1 and forms a positive training sample from the feature vector and the classification label.

More broadly, the processor 110 determines, for each respective window of events H₍ₜ_{ₐ}_{,t}_{_{b}}_{]}^{l} in the plurality of windows of events [symbol] ′, a respective classification label c∈[0, 1] indicating whether a particular type of event (e.g., an interruption) occurred within the first threshold amount of time A subsequent to the respective window/interval of time (tₐ, t_{b}]. For each respective window of events H₍ₜ_{ₐ}_{,t}_{_{b}}_{]}^{l} in the plurality of windows of events [symbol] ′, the processor 110 forms a positive training sample from the respective window of events H₍ₜ_{ₐ}_{,t}_{_{b}}_{]}^{l} and the respective classification label c, in response to the respective classification label c indicating that the particular type of event occurred within the first threshold amount of time A subsequent to the respective window/interval of time (tₐ, t_{b}], i.e., whenever c=1.

With reference again to FIG. 6, the processor 101 first generates positive samples by looking at the windows of events that precede each interruption. Particularly, suppose that an interruption (black circles in the illustration) occurs at time t at some location l, then the processor 110 considers the windows of events in the subset of windows of events at the location l that precede the interruption within the first threshold amount of time A. Such windows of events are labeled as positive training samples 502, and the corresponding feature vectors are paired with a classification label c=1 to form positive training samples. It should be appreciated that, although only one is shown for each interruption, multiple different preceding windows of events may be used to form multiple different positive training samples on the basis of one interruption.

In some embodiments, the processor 110 considers a window of events H_{(t-M,t-W]}^{l}, where W is a second threshold amount of time before the interruption. If a candidate window of events precedes the interruption by less than the threshold amount of time W, then the processor 110 ignores that window of events in the generation of positive training samples. The second threshold amount of time W is a non-zero value (e.g., 30 minutes) selected so that the machine learning model 124 does not learn features that are very close to the interruption. In other words, in some embodiments, for a given window of events, the processor 110 forms a positive training sample from the window of events only if the particular type of event (e.g., an interruption) occurred at a time t that is at least a second threshold amount of time W after the respective window/interval of time, but also within the first threshold amount of time A after the respective window/interval of time. The reason for ignoring the second threshold amount of time W is so that the machine learning model 124 does not learn patterns that become apparent only very close to the interruption. Although these might help improve the accuracy of predictions, the predictions made will not be useful because of the small time available for operators to react to the predictions.

With each positive training sample, the processor 110 also records the timestamp t at which the relevant subsequent interruption occurred. As will be discussed below, this timestamp t will be used split the training samples into training and validation sets. For each location l, the processor 110 also records all the windows for which a positive training sample was created. As will be discussed below, this is used to avoid overlap between the positive training samples and the negative training samples at each location l.

The method 300 continues with generating a plurality of negative training samples (block 340). Particularly, in order to generate negative training samples (i.e., feature-label pairs), the processor 110 determines which window of events in the windows of events [symbol] ′ should be labeled with a classification label c=0, indicating that a particular type of event (e.g., an interruption) did not occur within the first threshold amount of time A (e.g., 7 days) subsequent to the window of events. In some embodiments, for each respective window of events H₍ₜ_{ₐ}_{,t}_{_{b}}_{]}^{l} in the plurality of windows of events [symbol] ′, the processor 110 forms a negative training sample from the respective window of events H₍ₜ_{ₐ}_{,t}_{_{b}}_{]}^{l} and the respective classification label c, in response to the respective classification label c indicating that the particular type of event did not occur within the first threshold amount of time A subsequent to the respective window/interval of time (tₐ, t_{b}], i.e., whenever c=0.

In some embodiments, when the classification label c=0 for a particular window of events, the processor 110 only forms a negative training sample from the window of events if the window of events does not overlap with the window of events of any positive training sample at the same location l. In other words, for each respective window of events H₍ₜ_{ₐ}_{,t}_{_{b}}_{]}^{l} in the plurality of windows of events [symbol] ′, the processor 110 forms a negative training sample from the respective window of events H₍ₜ_{ₐ}_{,t}_{_{b}}_{]}^{l} and the respective classification label c, in response to (1) the respective classification label c indicating that the particular type of event did not occur within the first threshold amount of time A subsequent to the respective window/interval of time (tₐ, t_{b}] and (2) the respective window/interval of time (tₐ, t_{b}] not overlapping with a respective window of time of any of the plurality of positive training samples at the same location l. For this reason, in at least some embodiments, the processor 110 generates negative training samples only after generating the positive training samples.

With reference again to FIG. 6, after generating the positive training samples, the processor 101 generates negative training samples by looking at the windows of events that do not precede an interruption by the first threshold amount of time A. Such windows of events are labeled as negative training samples 504 if they do not overlap with any of the positive training samples 502 in the same event-location timeline 500, and the corresponding feature vectors are paired with the classification label c=0 to form negative training samples. However, if a window of events does not precede an interruption by the first threshold amount of time A, but does overlap with one of the positive training samples 502 in the same event-location timeline 500, then such a window of events is labeled as a rejected training sample 506, or otherwise, simply ignored.

In some embodiments, the processor 110 performs the negative training sample generation simultaneously or in combination with with the determination of the subset of windows of events from each event-location set H^{l} (e.g., the stepwise scan process discussed above). Particularly, in some embodiments, the processor 110 iteratively defines a window of time, determines a classification label, generates a positive or negative training sample from or ignores that window of time, and then slides the window to define the next window of time, repeating the process until tₘₐₓ^{l} is reached. In such embodiments, some efficiencies can be found. For example, in some embodiments, during the scan of each event-location timeline, if the current window of time overlaps with a positive training sample, the processor 110 slides the window of time to the end of the overlapped positive training sample. With reference to FIG. 6, it can be seen that between step 3 and 4, the window is slid to the end of the left-most positive training sample 502, thereby efficiently skipping over intermediate windows that would also overlap with the left-most positive training sample 502

The method 300 continues with training a machine learning model using the plurality of positive training samples and the plurality of negative training samples (block 350). Particularly, once the plurality of positive training samples and the plurality of negative training samples have been generated, the processor 110 trains the machine learning model 124 to learn the simplified predictor function simp_predict based on the plurality of positive training samples and the plurality of negative training samples. More particularly, the processor 110 trains the machine learning model 124 to determine a predicted value of the classification label c, given a monitoring window of events H_{(t-M,t]}^{l} at a particular location l. The output of the machine learning model 124 is a value between 0 and 1 indicating a probability that a particular type of event (e.g., an interruption) will occur within a first threshold amount of time A (e.g., 7 days) subsequent to the monitoring window of time (t-M, t].

In at least one embodiment, the processor 110 trains the machine learning model 124 in a supervised fashion by feeding the input feature vectors of each training sample into the machine learning model 124 and determining, on the basis of a comparison with the associated classification labels c, training losses. Based on each training sample, parameters (e.g., kernel weights, model coefficients, etc.) of the machine learning model 124 are updated and refined until satisfactory performance is achieved by the machine learning model 124. In one embodiment, the processor 110 optimizes model parameters using the hyperopt library.

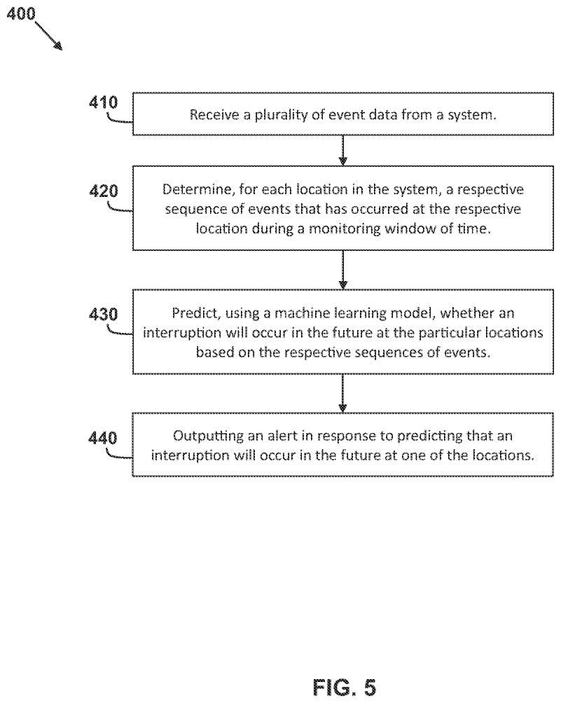

FIG. 5 shows a flow diagram for a method 400 for predicting possible future events in a system. The method 400 advantageously leverages the machine learning model 124 trained using the methods discussed above to enable accurate and real-time prediction of particular types of future events (e.g., interruptions) in a system. In this way, operators of such systems can be alerted prior to the occurrence of such events and have the opportunity to resolve issues in the system that might otherwise lead to undesirable outcomes such as interruptions.

The method 400 begins with receiving a plurality of event data from a system (block 410). Particularly, the processor 110 receives the event data stream(s) 106 from the monitored system 104. As discussed above, the event data stream(s) 106 at least includes data indicating events that occurred in the monitored system 104 and timestamps indicating the times at which the events occurred. Additionally, the event data stream(s) 106 may further include certain metadata, as discussed above. In at least some embodiments, the processor 110 stores the events from the event data stream(s) 106 in the database 102 (i.e., the event data 160).

The method 400 continues with determining, for each location in the system, a respective sequence of events that has occurred at the respective location during a monitoring window of time (block 420). Particularly, for some or all respective locations l∈L in the system 104, the processor 110 determines a sequence of events or, more particularly, a respective monitoring window of events H_{(t-M,t]}^{l}, e.g., using definition 2.9, that includes all events that occurred at the respective location l during a monitoring window of time, e.g., (t-M, t]. Each monitoring window of events H_{(t-M,t]}^{l} will be used as a basis for predicting whether a particular type of event (e.g., an interruption) will occur at the respective location l within the first threshold amount of time A subsequent to the monitoring window of time, e.g., (t-M, t].

The method 400 continues with predicting, using a machine learning model, whether an interruption will occur in the future at the particular locations based on the features of the formed sequences of events (block 430). Particularly, based on each monitoring window of events H_{(t-M,t]}^{l}, the processor 110 uses the trained machine learning model 124 to predict whether the particular type of event (e.g., an interruption) will occur at the respective location l within the first threshold amount of time A subsequent to the monitoring window of time, e.g., (t-M, t].

More particularly, in at least some embodiments, for each monitoring window of events H_{(t-M,t]}^{l}, the processor 110 extracts features therefrom and forms a feature vector using the same process described above for generating the positive and negative training samples. The processor 110 feeds the respective feature vector into the machine learning model 124 as input and determines an output of the machine learning model 124 based on the feature vector.

In at least some embodiments, the output of the machine learning model 124 is a probability between 0 and 1 that the particular type of event (e.g., an interruption) will occur at the respective location l within the first threshold amount of time A subsequent to the monitoring window of time, e.g., (t-M, t]. To translate the probability into a prediction, the processor 110 compares the output probability with detection threshold T. If the probability exceeds the detection threshold T, then the processor 110 predicts that the particular type of event (e.g., an interruption) will occur at the respective location l within the first threshold amount of time A subsequent to the monitoring window of time, e.g., (t-M, t]. In other words, the prediction process can be defined (definition 2.11) as follows. For any given location l and the corresponding window of events H_{(t-M,t]}^{l}, the processor 110 outputs a prediction that an interruption will occur whenever simp_predict(H_{(t-M,t]}^{l}≥T. The value of T can be adjusted to get a desired trade-off between the precision and recall.

In at least some embodiments, once the system outputs a prediction, that prediction remains active for a certain time period. This time period P is an adjustable parameter and, in some embodiments, is set equal to the first threshold amount of time A using in the training process discussed above. The reason for having an active prediction period is two-fold. First, due to training the machine learning model 124 to make predictions on a binary classification problem, the system does not know exactly when the interruption will occur. Thus, the duration when the prediction remains active gives provides a time interval for when the interruption is expected to occur. Second, the system can avoid creating duplicate predictions at the same location if an active prediction already has been made for that location. Finally, the system advantageously provides an operator with sufficient warning that gives the operators enough time to respond to the prediction before a failure occurs. This minimum warning duration (e.g., 30 minutes) is denoted W, as discussed above.

The method 400 continues with outputting an alert in response to predicting that an interruption will occur in the future at one of the locations (block 440). Particularly, the processor 110 perceptibly outputs, via some user interface, an alert in response to predicting that the particular type of event (e.g., an interruption) will occur at a respective location l within the first threshold amount of time A subsequent to the monitoring window of time, e.g., (t-M, t]. In some embodiments, the alert is provided to an operator of the monitored system 104 and at least indicates the location l at which the event is predicted to occur. In some embodiments, the processor 110 operates a display device or otherwise causes a display device to be operated to display a graphical alert on the display screen. In some embodiments, the processor 110 operates a speaker or otherwise causes a speaker to be operated to display a graphical alert on the display screen. In some embodiments, the processor 110 operates the network communications module 150 to transmit a message to some other device indicating the prediction, which causes that other device to perceptibly output the alert.

In at least some embodiments, the processor 110 suppresses the outputting of the alert in response to a prior alert having already been output within a predetermined amount of time (e.g., P) with respect to a prior prediction that that particular type of event (e.g., an interruption) will occur at the respective location. In other words, if there is already an active prediction that an event will occur at a particular location l, then the processor 110 does not send another alert predicting that same event will occur at the same particular location l.

### Evaluation Metrics and Cross-Validation

In addition to the methods for training and using the machine learning model 124, an emulator-based approach is disclosed for cross-validation of the data for temporal, non-i.i.d. data that contains time lagging features. The approach mimics the real-world deployment scenario and provides an estimate of an expected performance of the machine learning model 124 in production. This solves a major challenge faced by machine learning practitioners where the performance of the trained model drops significantly between training and deployment.

Two approaches for the evaluation and cross validation are discussed herein. Particularly, an initial approach is first presented, then its drawbacks are highlighted, and then the second emulator-based approach is presented.

In the initial approach, the training data is split by time. Particularly, due to presence of overlapping windows during the data generation process, the i.i.d. assumption of the data samples necessary for randomized cross-validation fails to hold. Further, due to the temporal order in which the data is generated, a randomized cross-validation would leak information from the future. Cross-validation techniques more suited to time-series data are hence more suitable for this disclosure. In this approach, the machine learning model 124 is trained and validated on different folds of the data. However, unlike randomized cross-validation, the chosen folds are sequential blocks of time.

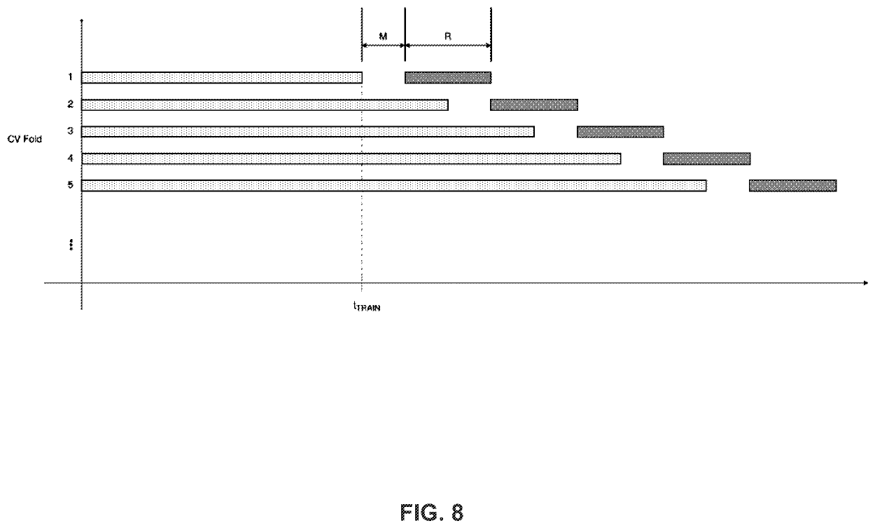

FIG. 8 shows a custom cross-validation split to avoid feature leakage. In the first fold, the machine learning model 124 is trained on generated data with timestamps that are in the time interval (−∞, t_{TRAIN}] and validated on generated data with timestamps from (t_{TRAIN}+M, t_{TRAIN}+M+R] where t_{TRAIN} is the end of training duration of the first fold, M is the monitoring window duration and R is the model retrain duration. In the second fold, the machine learning model 124 is trained on generated data with timestamps that are in the time interval (−∞, t_{TRAIN}+R] and validated on generated data with timestamps from (t_{TRAIN}+M+R, t_{TRAIN}+M+2R]. Similarly, in the kth fold, the machine learning model 124 is trained on generated data with timestamps that are in the time interval (−∞, t_{TRAIN}+(k−1)R] and validated on generated data with timestamps from (t_{TRAIN}+M+(k−1)R, t_{TRAIN}+M+kR].

The reason for not validating on the immediate M days after t_{TRAIN} is that, since the machine learning model 124 will be implemented in production, labels cannot be assigned to data within the last M days, as it is necessary to wait for future data to know whether these correspond to an interruption or not. Also, the machine learning model 124 cannot be validated on M days after the last day in training set because the features created for those timestamps would overlap with features in the training set since lagging M days feature are used, thereby causing feature leakage. The evaluation metrics used for this initial approach are precision, recall and f-score.

$$Precision = \frac{true positive samples}{true positive samples + false positive samples}$$

$$Recall = \frac{true positive samples}{true positive samples + false negative samples}$$

$$F - score = \frac{2 \times Precision \times Recall}{Precision + Recall}$$

One of the major challenges in deploying machine learning systems in real-world industrial settings is that the performance of models during experiments do not reflect the actual measured performance in production. The evaluation metric defined before suffers from the same problem. This is because in production, the machine learning model 124 is expected to be evaluated continuously as streams of new anomalous and interruption events occur. However, since our cross-validation samples come from generated data, positive samples include all data right before each interruption whereas negative samples include windows that are far away from interruptions. In real world testing, the observed data would be somewhere between the spectrum of positive samples and negative samples. Therefore, second emulator-based approach is defined which mimics real-world deployment.

In the second approach, an emulator-based approach is leveraged that that mimics real-world deployment. In this emulator-based approach, the training set split is created in exactly the same manner discussed with respect to the initial approach. However, the manner of validation is different. As mentioned, the problem with validating on the generated data is that they are easier to get right since they only include the windows right before interruptions or further away from interruptions. Thus, to emulate the real-world scenario, an inference is done whenever a new anomaly occurs at any of the location, the processor 110 forms a window of events at that location and time H_{(t-M,t]}^{l} and makes a prediction using the simplified predictor function simp_predict (definition 2.10) and the prediction threshold T (definition 2.11). Once such a prediction is made, it can either be a true positive, i.e., a successful prediction, or a false positive. A prediction made on location l at time t is a successful prediction if an interruption occurs at that location in the time interval [t+W, t+P], where W is the minimum warning duration and P is the active duration of that prediction.

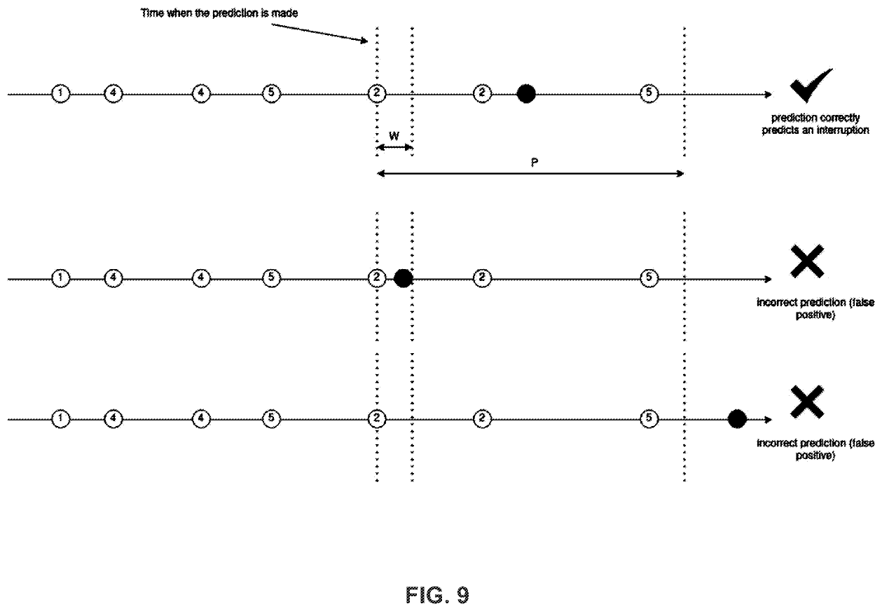

FIG. 9 shows the conditions under which a prediction is successful or a false positive. Inference is done similarly for all the anomalies that occur within the cross-validation duration at all the locations. Once validation step is completed for the current fold, the processor 110 moves to the next fold, retrains the machine learning model 124 on the corresponding training split and performs the validation step as described before. The processor 110 repeats this process until the last fold is reached. In the initial approach described above, each sample was evaluated, whereas in the emulator approach the processor 110 evaluates the predictions and not samples. Thus, the evaluation metrics are modified as follows:

$$Adjusted Precision = \frac{true positive predictions}{true positive predictions + false positive predictions}$$

$$Adjusted Recall = \frac{true positive predictions}{true positive predictions + predictable interruptions missed}$$

$$Adjusted F - score = \frac{2 \times Adjusted Precision \times Adjusted Recall}{Adjusted Precision + Adjusted Recall}$$

Thus, the performance of the machine learning model 124 is measured based on whether the machine learning model 24 successfully predicts whether the particular type of event (e.g., an interruption) occur within the first threshold amount of time A subsequent to the window of time, rather than on the basis of successfully predicting the classification label c of each particular positive and negative validation sample. In the experimental dataset, it was found that in some cases multiple interruptions would happen in close temporal proximity. Using the initial approach, the validation process would see multiple true positive samples when they were correctly predicted, however, in the emulator approach, these interruptions would account for only one successful prediction since the multiple interruptions would be covered by the same prediction.

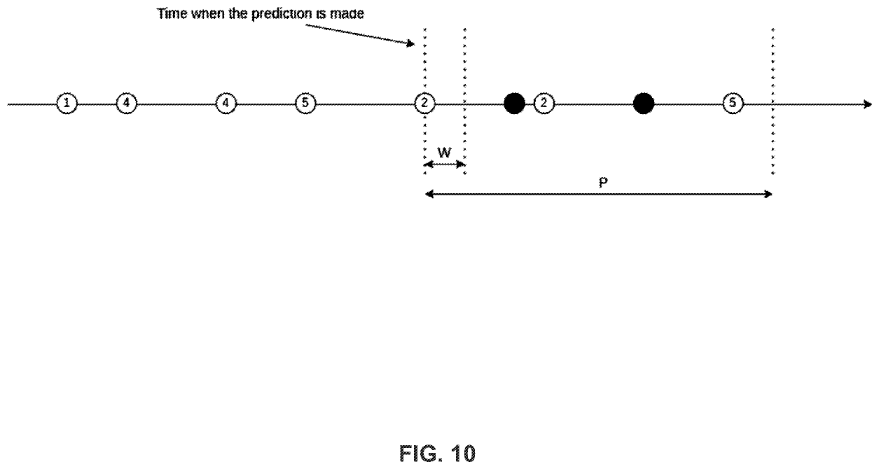

FIG. 10 shows a scenario where two interruptions occur in the same prediction interval. This leads to a single true positive prediction using the emulator approach, but two true positive samples using the initial approach. In the initial approach, this would have resulted in two true positives whereas in the emulator approach, this results in only a single true positive. Thus, the evaluation metrics in the initial approach artificially inflate the expected performance whereas the emulator approach gives a more reliable estimate of what can be expected in production.

### Explainability and Interpretability

Explanations are provided herein for the predictions of the machine learning model 124 using existing explainability frameworks. These explanations are useful in assisting the system operators in taking corrective actions. Particularly, in addition to the model accuracy, it is desirable for predictions to be interpretable. This means that machine operators that use the system are able to understand the factors that drive the prediction of the machine learning model 124. In general, as statistical learning techniques become more complex, their interpretability reduces. However, recent advances in explainable AI have enabled interpretability without sacrificing accuracy or generalizability of the predictions. One such technique which is utilized here is Shapley Additive Explanations which has been applied in varied settings. Shapley Additive Explanations work well with tree-based models like random forests and XGBoost by returning sharp values for each feature which represents the contribution of that feature towards a particular prediction. The predictions of the machine learning model 124 can thus be interpreted by plotting the individual shape values for each feature.

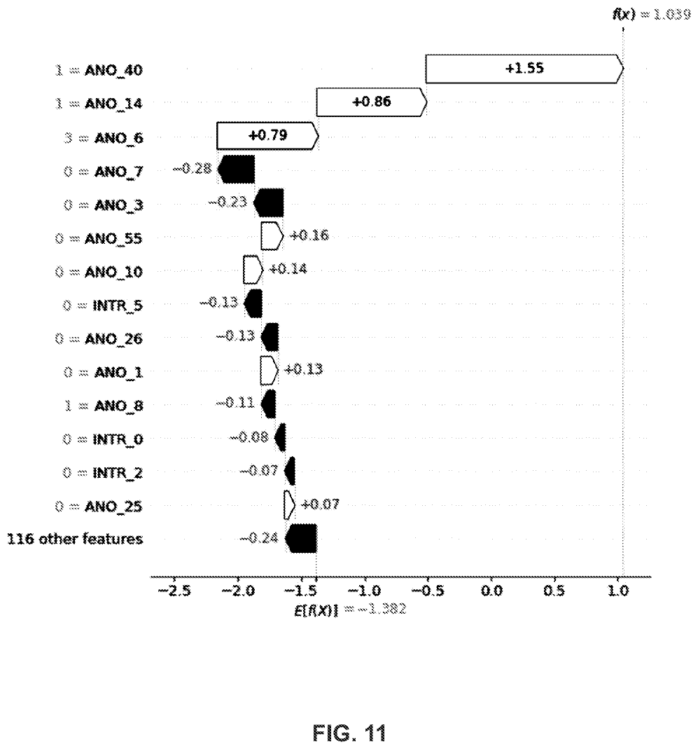

FIG. 11 shows an exemplary explanation of which events contribute to a predicted interruption. In some embodiments, the processor 110 operates a display device or otherwise causes a display device to be operated to display a graphical explanation (e.g., a plot or the like) that explains which events contribute to a predicted interruption. In FIG. 11, a waterfall plot is shown in which the horizontal axis denotes the logarithm of the odds of an interruption occurring. Thus, a value greater than 0 on the horizontal axis implies that the probability of interruption is greater than 0.5 and vice versa. The vertical axis shows the 14 features that have the maximum contribution towards the prediction. Each horizontal bar denotes the contribution of that particular feature. A white bar indicates that the corresponding feature contributed to an increase in the log odds (and thus increases the probability of an interruption) whereas a black bar indicates that the corresponding feature contributed to a decrease in the log odds. The longer the length of the bar, the higher is the contribution of that feature. E[f(X)] denotes the base rate of an interruption occurring and f(X) denotes the log odds of an interruption occurring for the prediction made on feature X. The plot shown is generated using the shape library. This works as an additional step in our existing workflow and doesn't impact the accuracy of the model. The performance overhead is also minimal.

### Experimental Results

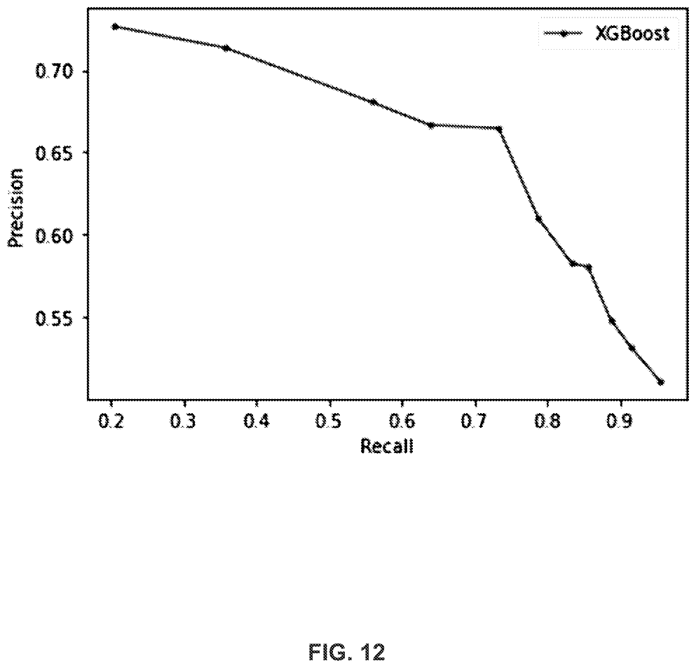

The systems and method disclosed herein were evaluated on a real-world dataset of anomalous-interruption events originating at the actual production lines. The results showed that the systems and method predicted failures with moderate accuracy and reduced the downtime of the production lines. The machine learning model 124 was trained on data generated from 19 unique locations. The generated data had 368 positive samples and 957 negative samples. Training, validation, and testing were performed on data collected from three different periods of time. The machine learning model 124 achieved an F-score of 0.70 on cross-validation set. Threshold selection was done by plotting the precision-recall curve. FIG. 12 shows a plot showing a resulting precision-recall curve. Since precision was favored over recall in the evaluation, a threshold T of 0.9 was chosen based on this curve. On cross-validation set, this threshold T gives a precision of 0.71 and recall of 0.36. Whereas on the test set, a precision of 0.76 and recall of 0.62 was achieved.

The high variance in the performance in cross-validation and test set is due to the small sample size of the cross-validation and test sets. Error analysis was also performed to identify where the machine learning model 124 was under-performing. It was found that the performance of the machine learning model 124 degraded on two particular locations. On further investigation, the interruptions at these two locations did not seem to follow a predictable underlying pattern of anomalies or interruptions. Hence, the machine learning model 124 did not accurately predict interruptions for these locations. However, if these two locations were excluded, the F-score on the cross-validation set increases to 0.74.

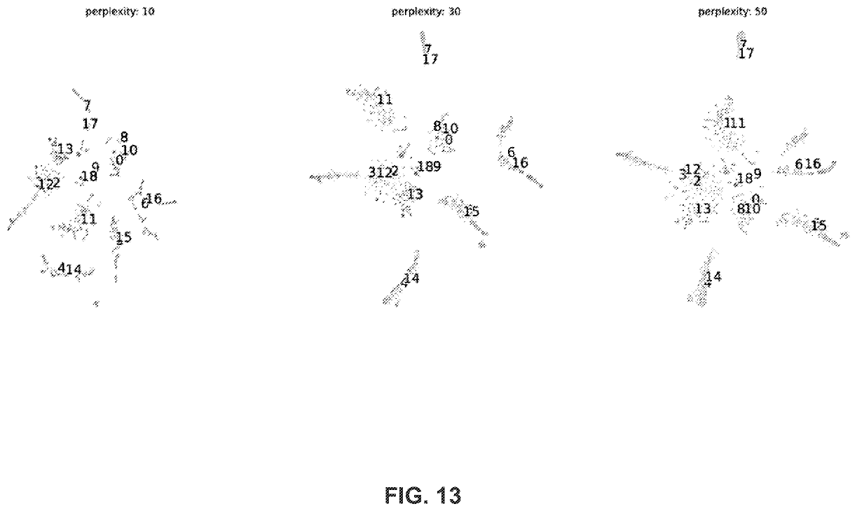

The distribution of the generated data across different locations was also reviewed. FIG. 13 shows a visualization of the generated data across different locations using t-SNE plots. It was found that data generated at certain locations form distinct clusters. The reason for this is that these locations have similar work stations and tool positions but belong to different lines within the factory. The two locations that were not accurately predicted by our model also clump into the two clusters numbered 4 and 14 in the t-SNE plot. These insights allow the machine learning model 124 to be curated to specific types of locations since the underlying distribution can be very different for different locations. At the same time, a significant number of locations do not separate out into well-defined clusters, yet the machine learning model 124 is able to predict interruptions accurately on these locations.

Embodiments within the scope of the disclosure may also include non-transitory computer-readable storage media or machine-readable medium for carrying or having computer-executable instructions (also referred to as program instructions) or data structures stored thereon. Such non-transitory computer-readable storage media or machine-readable medium may be any available media that can be accessed by a general purpose or special purpose computer. By way of example, and not limitation, such non-transitory computer-readable storage media or machine-readable medium can comprise RAM, ROM, EEPROM, CD-ROM or other optical disk storage, magnetic disk storage or other magnetic storage devices, or any other medium which can be used to carry or store desired program code means in the form of computer-executable instructions or data structures. Combinations of the above should also be included within the scope of the non-transitory computer-readable storage media or machine-readable medium.

Computer-executable instructions include, for example, instructions and data which cause a general-purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

While the disclosure has been illustrated and described in detail in the drawings and foregoing description, the same should be considered as illustrative and not restrictive in character. It is understood that only the preferred embodiments have been presented and that all changes, modifications and further applications that come within the spirit of the disclosure are desired to be protected.

What is claimed is:

1. A method for training a machine learning model to predict future events in a system, the method comprising:
receiving, with a processor, event data from the system, the event data indicating events that occurred in the system and times at which the events occurred;
determining, with the processor, a plurality of positive training samples based on the event data;
determining, with the processor, a plurality of negative training samples based on the event data; and
training, with the processor, using the plurality of positive training samples and the plurality of negative training samples, a machine learning model to predict, given a sequence of events that have occurred at a particular location during a window of time, whether a particular type of event will occur at the particular location within a first threshold amount of time subsequent to the window of time.

2. The method according to claim 1, wherein each training sample in the plurality of positive training samples and the plurality of negative training samples includes:
data defining a respective sequence of events that occurred at a respective location within the system and during a respective window of time; and
a classification label indicating whether the particular type of event occurred at the respective location within the first threshold amount of time subsequent to the respective window of time.

3. The method according to claim 2 further comprising, for each respective training sample in the plurality of positive training samples and the plurality of negative training samples:
extracting feature data from the respective sequence of events; and
forming a respective feature vector from the feature data extracted from the respective sequence of events,
wherein the data defining the respective sequence of events of the respective training sample includes the respective feature vector.

4. The method according to claim 3, wherein the events indicated in the event data are each one of a plurality of event types, the extracting the feature data from the respective sequence of events further comprising:
determining, for each respective event type in the plurality of event types, a respective count of how many events of the respective event type occurred at the respective location during the respective sequence of events,
wherein the respective feature vector includes the respective count for each event type in the plurality of event types.

5. The method according to claim 1 further comprising:
determining a plurality of sequences of events, each sequence of events in plurality of sequences of events including events that occurred at a same respective location within the system and during a respective window of time.

6. The method according claim 5, the determining the plurality of sequences of events further comprising:
determining, based on the event data, a plurality of event-location sets, each event-location set including all events in the event data that occurred at a same respective location within the system; and
determining, for each event-location set of the plurality of event-location sets, a respective subset of sequences of events, each sequence of events in the respective subset of sequences of events including events that occurred at the same respective location within a different respective window of time,
wherein the plurality of sequences of events includes the respective subset of sequences of events for each event-location set of the plurality of event-location sets.

7. The method according claim 6, the determining the respective subset of sequences of events further comprising:
determining, for each sequence of events in the respective subset of sequences of events, the different respective window of time by sliding the window of time by a predetermined time interval.

8. The method according to claim 5 further comprising:
determining, for each respective sequence of events in the plurality of sequences of events, a respective classification label indicating whether the particular type of event occurred at the respective location within the first threshold amount of time subsequent to the respective window of time.

9. The method according to claim 8, the determining the plurality of positive training samples further comprising, for each respective sequence of events in the plurality of sequences of events:
forming a positive training sample of the plurality of positive training samples from the respective sequence of events and the respective classification label, in response to the respective classification label indicating that the particular type of event occurred at the respective location within the first threshold amount of time subsequent to the respective window of time.

10. The method according to claim 9, the determining the plurality of positive training samples further comprising, for each respective sequence of events in the plurality of sequences of events:
forming a positive training sample of the plurality of positive training samples from the respective sequence of events and the respective classification label, in response to (i) the respective classification label indicating that the particular type of event at the respective location occurred within the first threshold amount of time subsequent to the respective window of time and (ii) the particular type of event occurred at the respective location after a second threshold amount of time subsequent to the respective window of time.

11. The method according to claim 8, the determining the plurality of negative training samples further comprising, for each respective sequence of events in the plurality of sequences of events:
forming a negative training sample of the plurality of negative training samples from the respective sequence of events and the respective classification label, in response to the respective classification label indicating that the particular type of event did not occur at the respective location within the first threshold amount of time subsequent to the respective window of time.

12. The method according to claim 11, the determining the plurality of negative training samples further comprising, for each respective sequence of events in the plurality of sequences of events:
forming the negative training sample in response to (i) the respective classification label indicating that the particular type of event did not occur at the respective location within the first threshold amount of time subsequent to the respective window of time and (ii) the respective window of time not overlapping with a respective window of time of any of the plurality of positive training samples at the same respective location.

13. The method according to claim 1 further comprising:
validating the machine learning model using an emulator-based approach in which performance is measured based on whether the machine learning model successfully predicts whether the particular type of event occurs within the first threshold amount of time subsequent to the window of time.

14. A method for predicting possible future events in a system, the method comprising:
receiving, with a processor, event data from the system, the event data indicating events that occurred in the system and times at which the events occurred;
determining, with the processor, a sequence of events including events that occurred at a respective location within the system and during a window of time preceding a current time;
predicting, with the processor, based on the sequence of events, using a machine learning model, whether a particular type of event will occur at the respective location within a first threshold amount of time subsequent to the window of time; and
perceptibly outputting, with a user interface, an alert in response to predicting that the particular type of event will occur at the respective location within the first threshold amount of time subsequent to the window of time.

15. The method according to claim 14, the predicting further comprising:
extracting feature data from the respective sequence of events;
forming a feature vector from the feature data; and
feeding the feature vector into the machine learning model.

16. The method according to claim 14, wherein the events indicated in the event data are each one of a plurality of event types, the extracting feature data from the respective sequence of events further comprising:
determining, for each respective event type in the plurality of event types, a respective count of how many events of the respective event type occurred at the respective location during the respective sequence of events,
wherein the feature vector includes the respective count for each event type in the plurality of event types.

17. The method according to claim 14, the predicting further comprising:
determining, using the machine learning model, a probability that the particular type of event will occur at the respective location within the first threshold amount of time subsequent to the window of time; and
comparing the probability with a predetermined detection threshold.

18. The method according to claim 17, the perceptibly outputting further comprising:
perceptibly outputting the alert in response to the probability exceeding the predetermined detection threshold.

19. The method according to claim 14, wherein:
the determining the sequence of events further comprises determining, for each respective location of a plurality of different locations within the system, a respective sequence of events including events that occurred at the respective location within the system and during the window of time; and
the predicting further comprises determining, for each respective location of the plurality of different locations within the system, whether the particular type of event will occur at the respective location within the first threshold amount of time subsequent to the window of time.

20. The method according to claim 14, the outputting further comprising:
suppressing the outputting of the alert in response to a prior alert having already been output within a predetermined amount of time with respect to a prior prediction that that particular type of event will occur at the respective location.
